(19) United States
(12) Patent Application Publication
(10) Pub. No.: US 2026/0070304 A1
(43) Pub. Date: Mar. 12, 2026

(54) STRONG, MODULAR, AND PROGRAMMABLE PLATE LATTICES HAVING KIRIGAMI CORRUGATIONS

(71) Applicant: Massachusetts Institute of Technology, Cambridge, MA (US)

(72) Inventors: Alfonso Parra Rubio, Somerville, MA (US); Klara Mundilova, Cambridge, MA (US); David Preiss, Somerville, MA (US); Erik D. Demaine, Cambridge, MA (US); Neil Gershenfeld, Cambridge, MA (US)

(73) Assignee: Massachusetts Institute of Technology, Cambridge, MA (US)

(21) Appl. No.: 18/828,425

(22) Filed: Sep. 9, 2024

Related U.S. Application Data
(60) Provisional application No. 63/512,673, filed on Jul. 10, 2023.

(51) Int. Cl. B32B 3/28; B25J 9/10; B29C 48/00; B29C 48/05; B29K 23/00; B32B 7/022; B32B 15/085; B32B 15/20; B32B 27/32

(52) U.S. Cl. CPC B32B 3/28; B25J 9/1075; B29C 48/0021; B29C 48/0022; B29C 48/05; B32B 7/022; B32B 15/085; B32B 15/20; B32B 27/32; B29K 2023/12; B32B 2307/546

(57) ABSTRACT

Custom folded 3-dimensional plate lattices are modularly assembled to form structures with single and double curvature for use in structural engineering and robotics applications. The plate lattice structural corrugation uses a building block strategy and incorporates custom modified unit cells based on a Kirigami Expanded Miura pattern. This transformation involves expanding the top and bottom zig-zag crease lines into facets and orienting them in space. The structure of these lattices allows for the design of anisotropies in their flexural stiffness by alternating between the Maxwell criterion on bending-dominated and stretch dominated cells. These anisotropies can have value differences of up to 24 times with the same geometry, making them ideal for robotic morphing applications.

### CROSS-REFERENCE TO RELATED APPLICATION

This application claims the benefit of priority of U.S. provisional application No. 63/512,673, filed Jul. 10, 2023, the contents of which are herein incorporated by reference.

### BACKGROUND OF THE INVENTION

The present invention relates to 3D plate lattices for use in engineering and robotics applications and, more particularly, to strong, modular, and programmable plate lattices having Kirigami corrugations.

Architected materials are ubiquitous and extensively used across diverse industries, including aerospace, architecture, furniture, and packaging. These materials possess a distinctive characteristic, whereby their properties, whether mechanical, thermal, or acoustic, are predominantly dictated by their geometrical arrangement, rather than their material composition.

From the perspective of lightweight engineering, architected materials enabled the creation of structures with superior mechanical performance at low mass cost. This has significantly benefited industries such as aerospace, automotive, naval, and wind power, enabling them to construct structures that push the limits of what can be achieved at the same mass budget.

Sandwich structures are widely utilized architected materials, irrespective of their core structure. The transition from monocoque to sandwich panel fuselages in the de Havilland Mosquito [1] marked the beginning of industrialized production of sandwich panels, particularly those with honeycomb cores. These panels offer superior flexural rigidity per unit mass and unit cost compared to monolithic materials [2]. However, honeycombs encounter issues with moisture absorption within their cells during operation [3], high costs for small production runs, inefficient milling processes for creating 3-dimensional shapes [2], and anticlastic deformations when bent to form curved panels [1].

Numerous studies have proposed new core geometries to address these issues. Open-cell geometries [4] made from metals [5] and composites [6] were first proposed as alternative truss-based cores. However, they encounter challenges in providing accurate three-dimensional (3D) shapes and suffer from labor-intensive manufacturing methods. Another proposal is flexible cells for monoclastic deformation, which are intended for use in morphing structures [7] [8]. Nevertheless, these cells have an encapsulated volume that absorbs moisture and encounter difficulties in providing custom 3D shapes.

Folding approaches play a big role in core structure research. Kirigami-inspired methods allow for the creation of complex single curvature [9], double curvature [2], and custom stiffness [10] but also encapsulate closed volumes. Other folded strategies were proposed to tackle shape, moisture ingestion and high structural efficiency using Miura-ori folds [11] [12] [13] but generating custom doubly curved shapes is still a challenge.

Additionally, all the core geometries share two significant inflexibilities. Firstly, they are primarily designed for static applications. Secondly, the interface between the core material and the sandwich surface is at points or edges, necessitating the use of structural adhesives, welding, or co-curing strategies for assembly.

As can be seen, there is a need for low cost, efficient, flexible 3D architected material core geometries that achieve custom double curved shapes, do not exhibit moisture absorption, and do not require structural adhesives, welding, or co-curing strategies for assembly.

The present disclosure provides Kirigami-based corrugations for engineering and robotic applications, which enable the creation of architected materials with programmable compliance and shape. Additionally, the manufacturing method of arbitrary crease patterns may be simplified through discretely assembled origami. One of the objectives of the present invention is to provide corrugated structures that can be used dynamically in robotics or morphing structures.

### SUMMARY OF THE INVENTION

In one aspect of the present invention, there is disclosed a structure having a core assembled from Kirigami expanded Miura crease pattern modules that are mechanically joined to both a top and a bottom layer.

In another aspect of the present invention, there is disclosed a method of manufacturing a structure comprising assembling a core from modules having Kirigami expanded Miura crease patterns and joining the core with a top surface and with a bottom surface by a step selected from the group consisting of bolting, riveting, co-curing, gluing, and any combination thereof.

These and other features, aspects and advantages of the present invention will become better understood with reference to the following drawings, descriptions, and claims.

### BRIEF DESCRIPTION OF THE DRAWINGS

FIG. 1A is a cross sectional view of a passenger aircraft horizontal tail plane (HTP) built with Kirigami corrugations;

FIG. 1B is a perspective view of a morphing wing;

FIG. 1C is a side view of a doubly curved large-scale tentacle with two degrees of freedom (DOF);

FIGS. 2A-2E depict a schematic illustration of a transformation from Miura-ori to Kirigami expanded Miura;

FIG. 3A is a schematic view of a Kirigami expanded Miura with xy-parallel planes;

FIG. 3B is a schematic view of a Kirigami expanded Miura with single curvature;

FIG. 3C is a schematic view of a Kirigami expanded Miura with double curvature;

FIG. 4A is a perspective view of a stretch dominated cell;

FIG. 4B is a perspective view of a bending dominated cell;

FIG. 5A is a schematic view of a discretely assembled origami structural shaped core showing its assembly motion with a detail view of the cell-to-cell join;

FIG. 5B is a schematic view thereof;

FIG. 5C is a crease map of cells thereof;

FIG. 6A is a perspective view of experimental specimens;

FIG. 6B is a force-displacement plot obtained therefrom;

FIG. 7A is a force-displacement plot of four specimens under a three-point bending test;

FIG. 7B is a view of the specimens thereof, shown with maximum deflection;

FIG. 8A is a side view of an actuated morphing wing;

FIG. 8B is a detail view of a tendon routing system therefor;

FIG. 8C is a side view of a large scale tentacle with 2 DOF;

FIG. 8D is a front view thereof;

FIG. 9A is a perspective view of a doubly curved shell;

FIG. 9B is front view thereof; and

FIG. 9C is a view of cross sections of an HTP.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The terms “faces” and “facets” are sometimes used interchangeably herein.

Broadly, an embodiment of the present invention provides structures assembled from folded modules with a Kirigami expanded Miura crease pattern.

The Miura-ori pattern has two families of creases. One family of creases lies on parallel zig-zag polylines. Their mountain or valley assignment is constant along a single polyline, but alternates between neighboring zig-zag polylines. Those creases in their folded state are referred to herein as xy-corrugations. The other family of creases lies on y-parallel lines. On a single line, the crease assignments alternate between mountain and valley folds. Those creases in their folded state are referred to herein as yz-corrugations. Miura-ori patterns have applications as foldcores [14], where the folded pattern is sandwiched between two planes that contain the folded zig-zag creases. However, joining the Miura-ori pattern along the folded zig-zag creases with the sandwich planes is challenging.

The Kirigami Expanded Miura is a modification of the Miura-ori crease pattern, a transformation that enables the contact between the new core and the top and bottom surfaces to be at facets, providing more accessible, reversible, and recyclable joining methods such as bolting and riveting. Folded cores with a desired shape can be generated without post-processing operations to form the core material to the target surface. Additionally, the open cell type of this core eliminates issues related to water ingestion.

To simplify the mechanical joining between the corrugation and the adjacent structure (such as a centroid for continuum robotics, a skin for a facade, or other corrugation to assemble cellular materials), a modification of the Miura-ori crease pattern that transforms the vertices of the tessellation into facets has been developed to enable a wider range of joining methods for structural use, e.g., bolting, riveting, co-curing, gluing, or combinations thereof. New faces are added by extruding the creases of the tessellation to faces. To preserve developability of the pattern, some of the extruded faces (namely non-rectangular faces) are removed, resulting in a Kirigami Expanded Miura tessellation.

The transformation method of the Miura-ori pattern into the Kirigami expanded Miura pattern is described by a series of equations. A folded state M of a (nₓ×n_{y})-Miura-ori pattern is sandwiched between two xy-parallel planes Π₁ and Π₂. The corrugation is constructed with vertex locations V_{i,j} and lengths (lₓ, l_{y}) where lₓ>0 and l_{y}>0 that specify the zig-zag shape of the xy-corrugation; a distance L between two neighboring xy-corrugations with same crease assignment; and a height or distance h between the two sandwich planes Π₁ and Π₂. For 0≤i<nₓ and 0≤j<n_{y}, the vertices of the folded state can be written as

$${V}_{i , j} = ( {l}_{x} i , Lj / 2 + {r}_{i + 1} {l}_{y} , {r}_{j} h ) , \qquad ( 1 )$$

where rₖ is the remainder of k when dividing by two and k is a subindex of r equal to i+1.

With a lower base plane having dimensions (bₓ, b_{y}), the yz-corrugations are extruded by bₓ/2 in x-parallel direction to both sides. This splits each vertex V_{i,j} of M into two vertices

$${V}_{i , j}^{+} and {V}_{i , j}^{-} ,$$

that is,

$${V}_{i , j} ↦ {V}_{i , j}^{\pm } = {V}_{i , j} \pm ( {b}_{x} / 2 , 0 , 0 ) where 0 < {b}_{x} < {l}_{x} . \qquad ( 2 )$$

The resulting modified tessellation M′ has new rectangular faces corresponding to the yz-corrugations of M, and new creases of length bₓ in the zig-zag polylines, resulting in modified xy-corrugations. Note that M′ is still rigidly foldable, but not flat foldable as the sum of opposite angles of a vertex does not add up to π.

The modified xy-corrugations of M′ by b_{y}/2 are extruded in y-parallel direction to both sides. This splits each vertex

$${V}_{i , j}^{\pm }$$

of M′ Into two ventices

$${V}_{i , j}^{\pm +} and {V}_{i , j}^{\pm -}$$

that is,

$$\begin{matrix}\begin{matrix}{V}_{i , j}^{+} ↦ {V}_{i , j}^{+ \pm } = {V}_{i , j}^{+} \pm ( 0 , {b}_{y} / 2 , 0 ) , \\ {V}_{i , j}^{-} ↦ {V}_{i , j}^{- \pm } = {V}_{i , j}^{-} \pm ( 0 , {b}_{y} / 2 , 0 ) ,\end{matrix} & where 0 < {b}_{y} < {l}_{y} .\end{matrix} \qquad ( 3 )$$

The resulting modified tessellation M″ has two types of new faces, rectangular (with inclination angle ψ) and parallelogram. The former corresponds to extruded vertices of M, the latter to the extruded zig-zag creases of M′, respectively. This modification breaks the developability of the pattern, as the sum of angles around a vertex does not equal 2π. The newly added parallelogram faces are removed to obtain the Kirigami Expanded Miura pattern M′″.

The pattern M′″ contains three types of faces: bottom faces referring to the faces that lie in the lower sandwich plane Π₁; top faces referring to the faces that lie in the upper sandwich plane Π₂; and all other (inclined) faces. Note that the vertices of the initial Miura pattern M coincide with the centers of the top and bottom faces of M′″.

The Kirigami Expanded Miura pattern may be customized to fill the area between the xy-plane Π_{xy} and a smooth, well-behaved surface Σ corresponding to a 3D function by appropriate “trimming”. Separation into unit-cells or strips is beneficial for fabrication.

The user may specify the intended supporting points V_{i,j} of the corrugation by three lengths (lₓ, l_{y}, L), reasonable target heights h_{i,j}, and reasonable target normal vectors n_{i,j} of the top faces (that is, for odd j) of the corrugation. Furthermore, the user can specify the dimensions (bₓ, b_{y}) of the lower base planes, and the inclination angle ψ of the rectangular faces corresponding to the extruded yz-corrugation. The user may thus specify any combination of the above-listed criteria.

The provided user-input allows us to define the base points of the corrugation by modifying Equation (1) to

$${V}_{i , j} = ( {l}_{x} i , Lj / 2 + {r}_{i + 1} {l}_{y} , {r}_{j} {h}_{i , j} ) .$$

For each bottom base point, the bottom faces having vertices

$$\{ {V}_{i , j}^{+ +} , {V}_{i , j}^{- +} , {V}_{i , j}^{+ -} , {V}_{i , j}^{- -} \}$$

are constructed as in Equations (2) and (3).

For odd j, let Π_{i,j} be the top base plane incident to V_{i,j} that is orthogonal to normal vector n_{i j}. To obtain the vertices of the modified top faces, set v_{±}=(0, ±cos ψ, sin ψ) and intersect the top base planes with v_{±}-parallel lines containing the corners of adjacent lower faces, resulting in

$$\begin{matrix}{V}_{i , j}^{--} = {V}_{i - 1 , j}^{- +} + \frac{( {V}_{i - 1 , j}^{- +} - {V}_{i , j} ) \cdot {n}_{ij}}{{V}_{+} \cdot {n}_{ij}} {V}_{+} , \\ {V}_{i , j}^{+ -} = {V}_{i - 1 , j}^{++} + \frac{( {V}_{i - 1 , j}^{++} - {V}_{i , j} ) \cdot {n}_{ij}}{{V}_{+} \cdot {n}_{ij}} {V}_{+} , \\ {V}_{i , j}^{- +} = {V}_{i - 1 , j}^{--} + \frac{( {V}_{i + 1 , j}^{--} - {V}_{i , j} ) \cdot {n}_{ij}}{{V}_{-} \cdot {n}_{ij}} {V}_{-} , \\ {V}_{i , j}^{++} = {V}_{i + 1 , j}^{+ -} + \frac{( {V}_{i + 1 , j}^{+ -} - {V}_{i , j} ) \cdot {n}_{ij}}{{V}_{-} \cdot {n}_{ij}} {V}_{-} ,\end{matrix}$$

the corners of the constructed top faces, where v expresses a coordinate point. Let the union of the corners of the top and lower faces be the vertices of the customized Kirigami Extruded Miura-ori crease pattern that has the same face topology as the corresponding Kirigami Extruded Miura.

Note that in most cases, the customized Kirigami Extruded Miura is not developable without additional cuts that result in connected components of groups of faces. A crease pattern may be obtained with at most [n_{y}/2] connected components. Note however, that often it might be beneficial to define even smaller groups of connected faces, as discussed below.

The inclined creases of the customized Kirigami Extruded Miura are parallel. The adjacent inclined faces may be joined into a single developable strip. Furthermore, as the bottom base planes are rectangles, and the bottom holes are congruent, two strips of inclined faces may be joined by the developed bottom faces.

In case the Kirigami Extruded Miura is cut with xy-parallel planes, the top faces are also congruent. In this case, two strips of inclined faces may be joined by the developed top faces. This results in global development without additional cuts.

If, however, the top surface is constant in x-direction (the normal vectors are orthogonal to the x-axis, and the heights alternate between points on the same zig-zag), the top faces are still rectangles, but of different size. Furthermore, the dimensions of the top faces alternate between points on the same zig-zag. By making a cut in every second top face, two strips of inclined faces may be joined by every second top face.

For doubly curved surfaces, the top faces are in general not rectangular. Thus, pairs of strips of inclined faces joined along the bottom faces and attached top faces may only be unrolled, resulting in [n_{y}/2] groups of faces.

Corrugations with controlled flexural stiffness may be achieved by selecting which cells satisfy Maxwell's Stability Criterion. In cellular solid theory, Maxwell's Stability Criterion determines whether the lattice microstructure deformation is bending dominated or stretch-dominated. Studies have shown that, at the same relative density values, stretch-dominated geometries have significantly higher stiffness and strength than bending dominated geometries. This geometrical characteristic can be utilized to selectively lower the flexural modulus value in selected sections of the corrugation, enabling actuation of these sections using tendons. This approach opens new design possibilities for morphing structures and robotics using structural corrugations. The pattern may be customized to fill the space between a planar and a curved boundary.

Most folding patterns exhibit kinematics similar to a parallel mechanism, where the crease pattern responsible for the formation of a desired 3D shape follows a continuous rigid-folding motion. This motion entails a change in the angle of planar neighbor facets composing the creases [16]. However, the challenge of finding a manufacturing method that meets these geometric constraints, only bending the creases without stressing in-plane the facets of the stock material, is highly intricate.

A modularly constructed origami may address this kinematic issue. Discrete origami is a method for simplifying crease patterns (e.g., smaller crease patterns) of folded structures into simpler unit cells that can be assembled modularly into larger structures, with neighboring cells sharing geometric boundaries. This approach involves isolating the unit cell that constitutes the tessellation and discretely assembling each cell to its adjacent cell using the same boundary conditions. Modular construction offers two advantages. First, it reduces the overall number of creases, simplifying the manufacturing process. Simpler crease patterns can be produced through well-known methods such as cold metal forming, double face milling, perforated creases, or combinations thereof. Second, it enables the construction of arbitrarily large structures, as the discrete nature of the process removes the manufacturing method size constraint from the overall size of the structure [17].

Double face milling the crease pattern on the material takes advantage of the stacked configuration of the material. Registration marks may be added when designing the crease pattern which may be decomposed into two parts, isolating peaks and valleys. This results in distributing peaks to one side of the aluminum composite and valleys to the opposite side, enabling clean folding of the material with minimal bending strain.

The above-mentioned decomposition has the drawback that additional joining is needed. Fabricated models have overlaps between adjacent unit-cells and strips, which results in some of the base faces becoming doubly covered. To ease fabrication, material thickness may be incorporated into implementation. In particular, the overlapping faces and trim may be offset by a small amount. If the joint is made by riveting, holes are carefully placed into pairs of top and bottom faces.

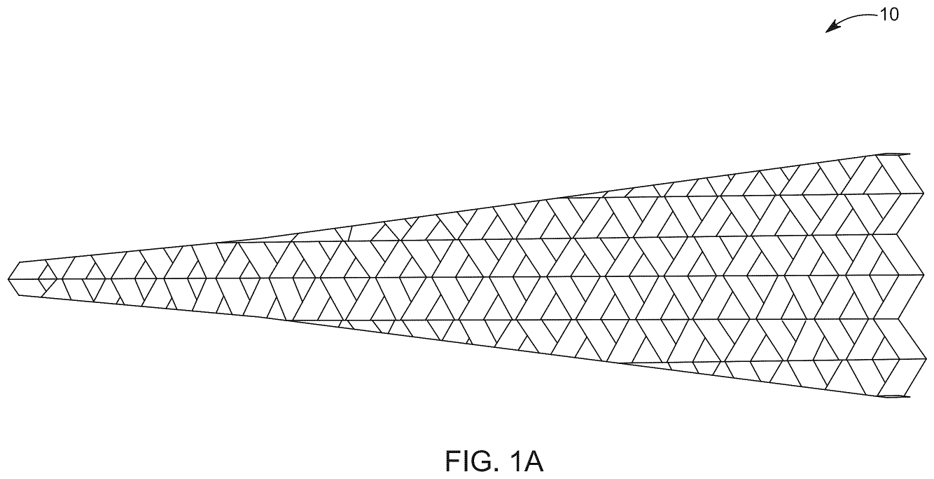

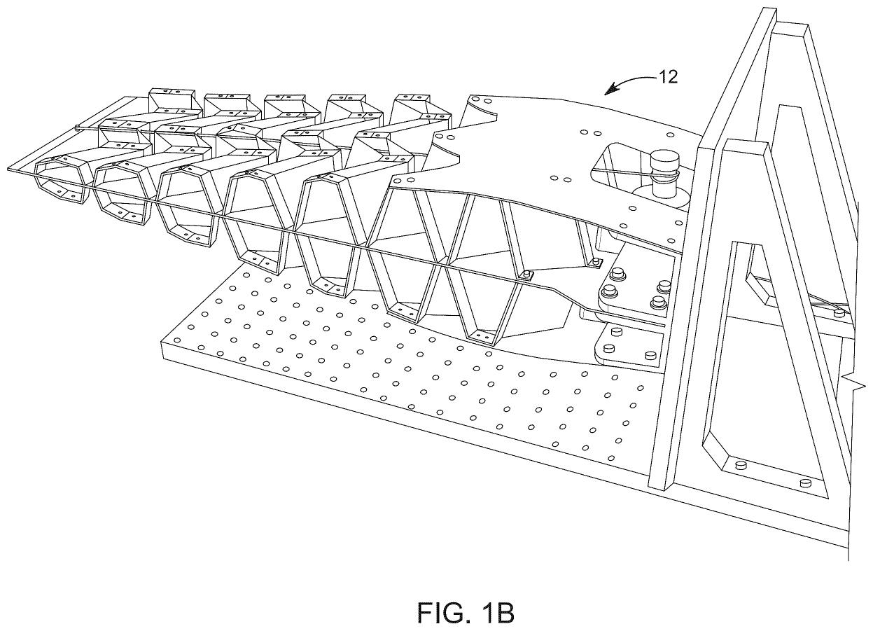

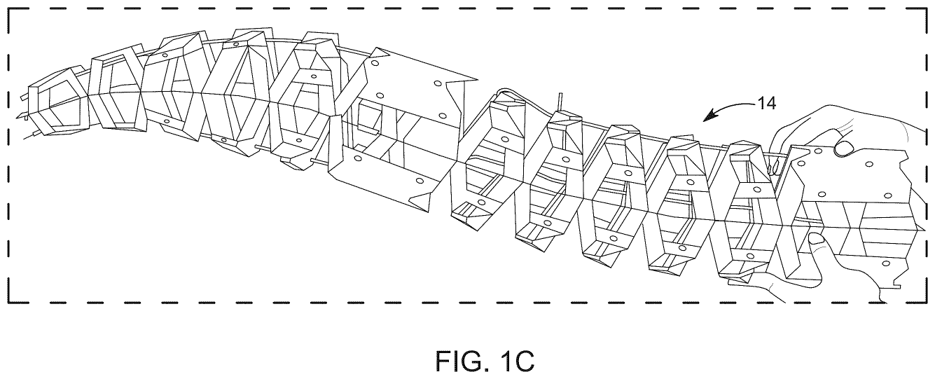

Referring now to FIGS. 1A, 1B, 1C, 2A, 2B, 2C, 2D, 2E, 3A, 3B, 3C, 4A, 4B, 5A, 5B, 5C, 6A, 6B, 7A, 7B, 8A, 8B 8C, 8D, 9A, 9B, and 9C, FIGS. 1A, 1B, and 1C illustrate 3D plate lattices (10, 12 and 14, respectively) with custom compliance, including static structures and robots, for experimental testing and practical applications in engineering and robotics.

Specimens are fabricated using the router module RM-A of a Zund G-3 L-2500 equipped with a 2 mm end mill R502. The material used is Hylite, a 1.2 mm aluminum composite panel from 3A Composites formed of 0.8 mm polypropylene core sandwiched between two layers of 0.2 mm aluminum. Mirroring one of the isolated crease patterns along the axis, flip the material. Then, using the machine, first mill the registration marks and engrave the first creases to a depth of 0.6 mm. Next, flip the stock material along the axis and use the registration module of the Zund to locate the previously milled reference points and proceed to mill the rest of the creases with the same depth values. Mill holes to assemble the structure using rivets.

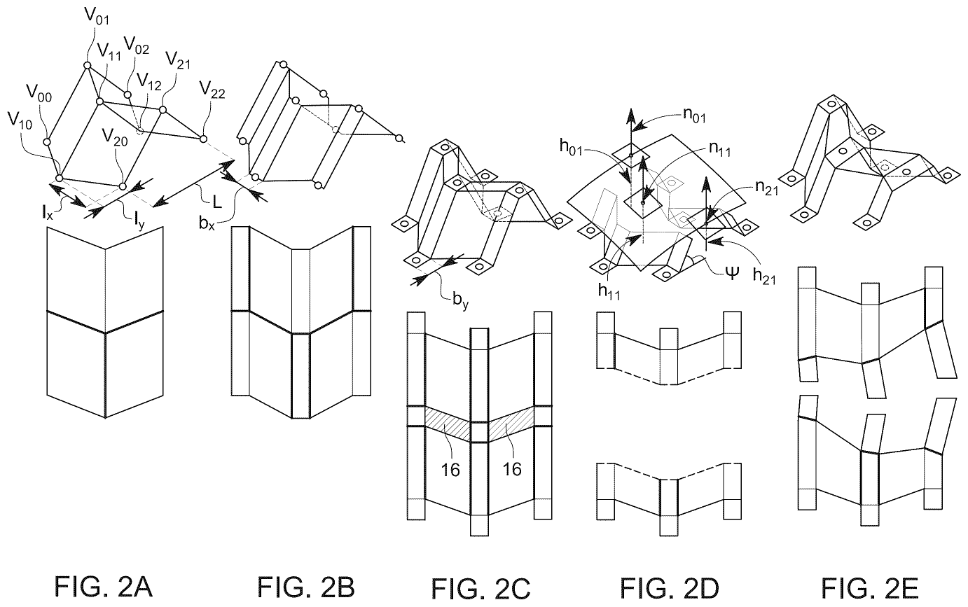

FIGS. 2A-2E illustrate the modifications of the well-known Miura-ori pattern (FIG. 2A), which is a rigid and flat foldable origami pattern comprising parallelograms, to obtain the Kirigami expanded Miura pattern (FIG. 2E) of the present subject matter, folding and unfolding it to fit arbitrary surfaces. The intended supporting points or vertex locations V_{i,j} of the folded state of the Miura-ori pattern are a function of user specified lengths lₓ and l_{y} that specify the zig-zag shape of the xy-corrugation; a distance L between two neighboring xy-corrugations with same crease assignment; a target height h_{i,j} between the two sandwich planes, and reasonable target normal vectors n_{i,j} of the top faces (that is, for odd j) of the corrugation. Furthermore, the user can specify the dimensions (bₓ, b_{y}) of the lower base planes and the inclination angle ψ of the rectangular faces corresponding to the extruded yz-corrugation (see FIG. 2B). The newly added parallelogram faces (12 in FIG. 2C) corresponding to the extruded zig-zag creases are removed (FIG. 2D) to obtain the Kirigami Expanded Miura pattern (FIG. 2E).

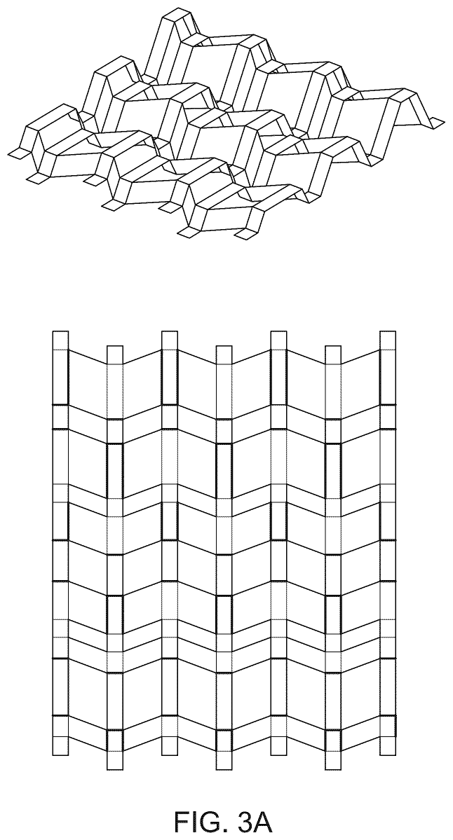

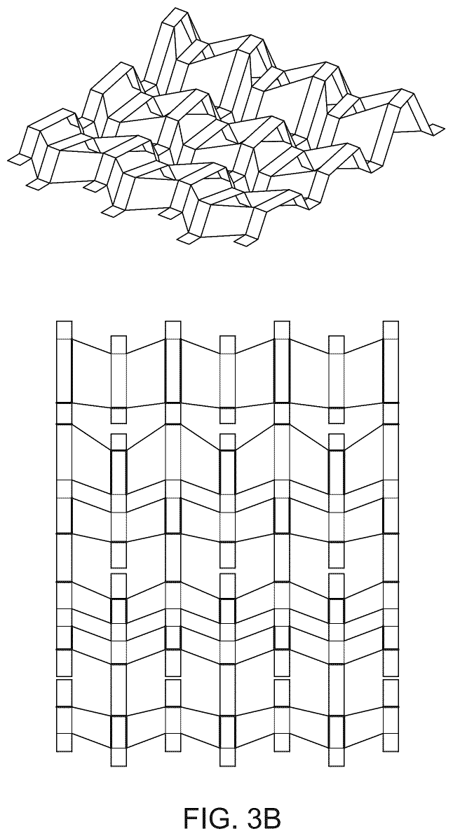

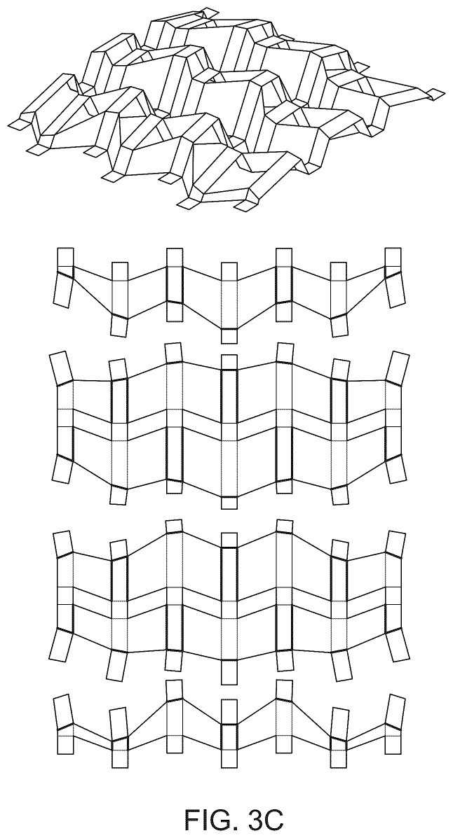

Kirigami expanded Miura corrugations and their crease maps are shown in FIGS. 3A, 3B, and 3C. The corrugation of FIG. 3A has xy-parallel planes; the corrugation of FIG. 3B exhibits single curvature; and the corrugation of FIG. 3C exhibits double curvature.

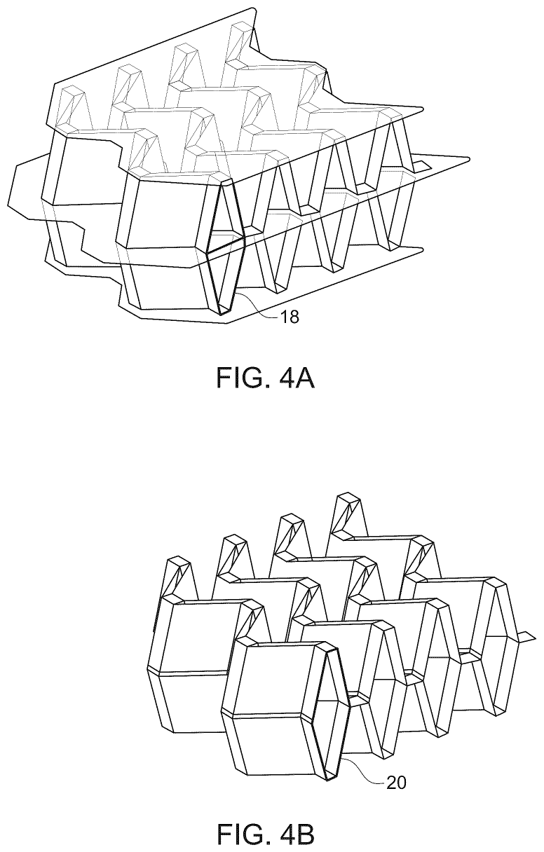

FIGS. 4A and 4B illustrate implementation of the Maxwell Stability Criterion to control flexural stiffness. A stretch dominated cell (18) is illustrated in FIG. 4A and a bending dominated cell (20) is illustrated in FIG. 4B. The geometry of FIG. 4A has higher stiffness and strength than the geometry of FIG. 4B.

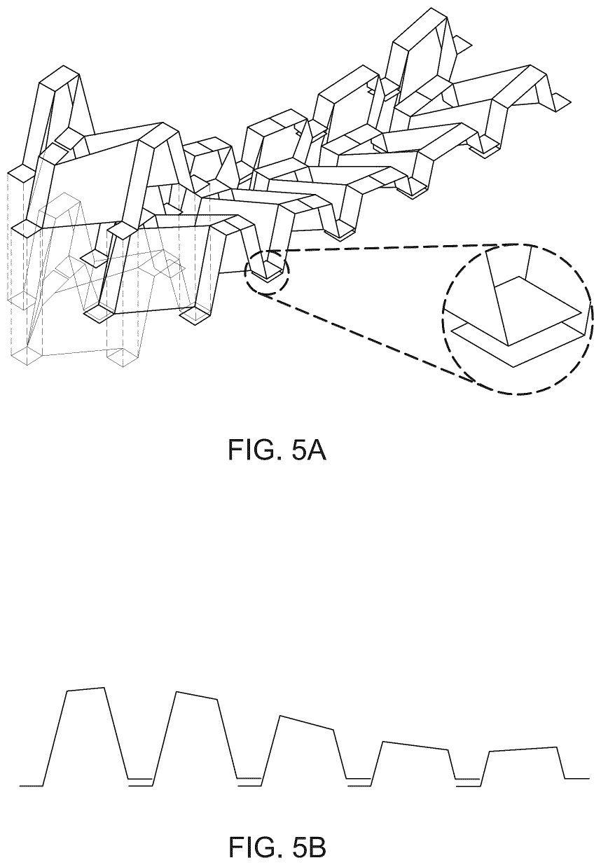

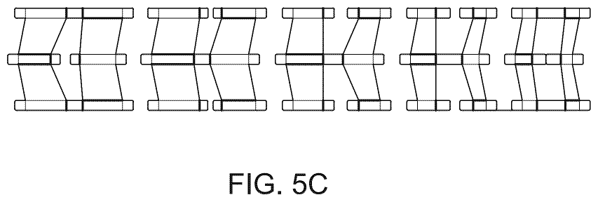

As shown in FIG. 5A, a structural shaped core is assembled from discretely assembled origami modules. Assembly motion is illustrated by the left end cell and the cell to cell join is shown in the enlarged detail. FIG. 5B is a schematic front view of the assembled corrugation of FIG. 5A and FIG. 5C is a crease map of its cells.

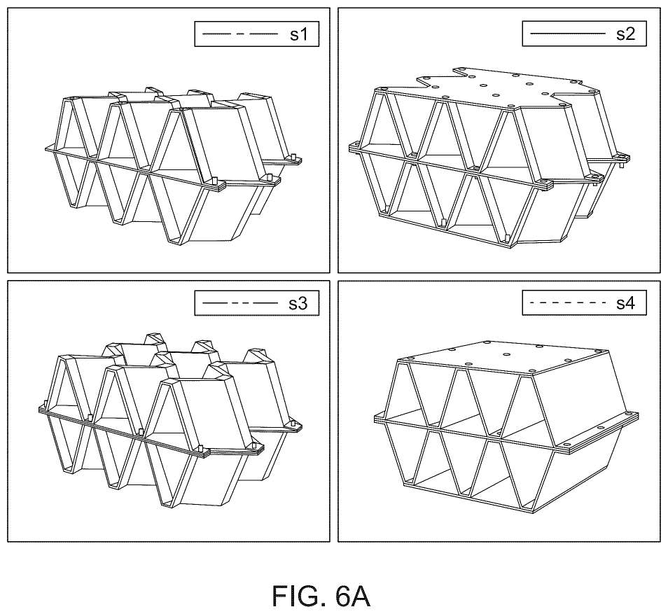

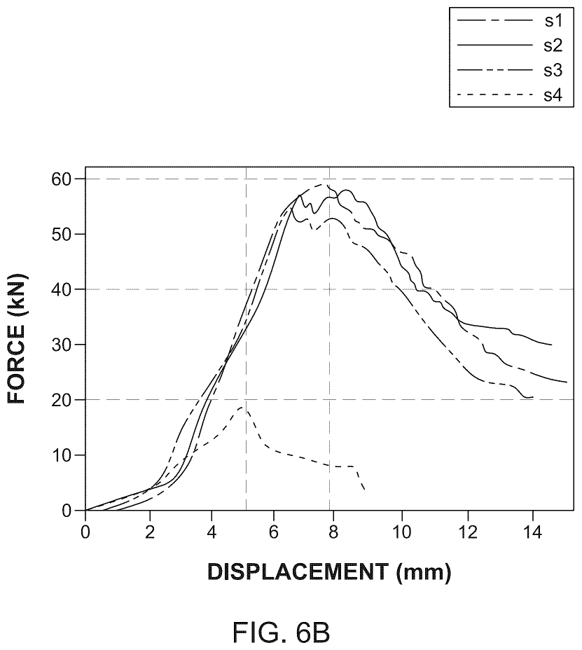

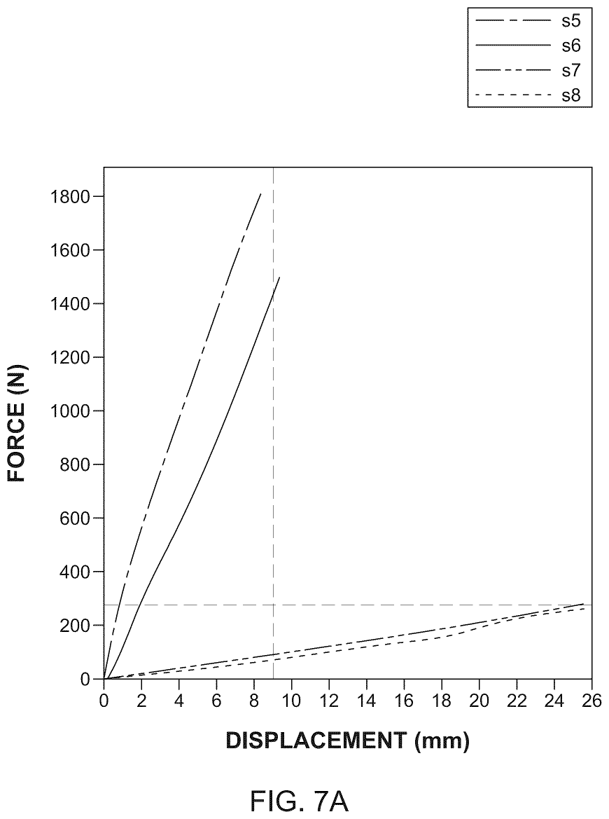

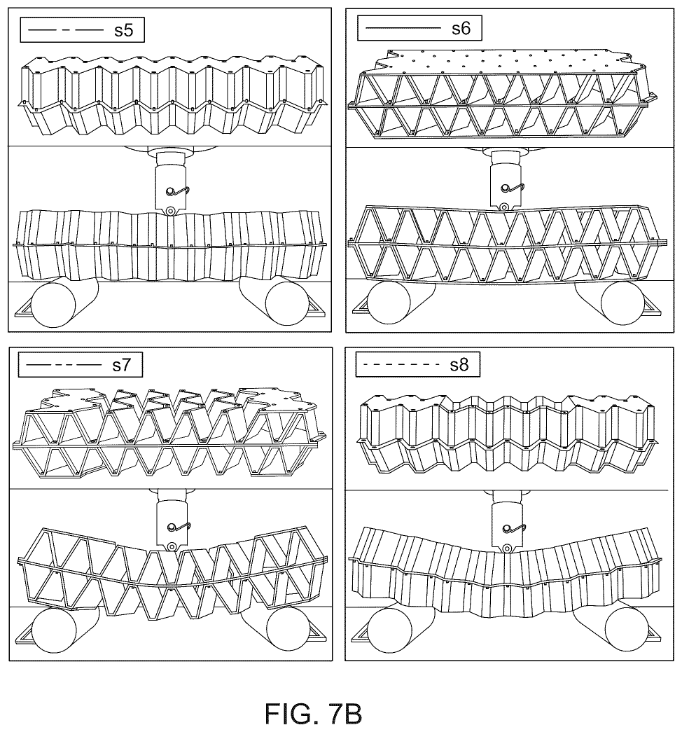

Experimental evaluation of the compressive and flexural behavior of folded corrugations is illustrated in FIGS. 6A, 6B, 7A, and 7B. Eight specimens (s1, s2, s3, s4 shown in FIG. 6A and s5, s6, s7, and s8 shown in FIG. 7B) underwent axial-load compression and three-point bending testing using an Instron 5985 with a 250 kN load cell. All specimens shared the same unit cell and the following parameters: L=68 mm, bₓ=b_{y}=11 mm, ψ=70o, lₓ=28.5 mm, l_{y}=29.5 mm, and thickness=1.2 mm.

Origami specimens s1, s2, s3, and s4 having 2 by 2 by 3 cells were subjected to a uniaxial compression test. The specimens are identified as follows:
s1: continuum.
s2: discrete with stretch-dominated cells.
s3: discrete with bending dominated cells.
s4: straight corrugation.

The performance of the four specimens can be seen in Table 1, below, and FIG. 6B. Note that specimen s1 (continuum) exhibited the highest load: mass ratio and the highest effective elastic modulus, yet specimen s3 (discrete with bending dominated cells) withstood the highest maximum load.

TABLE 1
UNIAXIAL COMPRESSION TEST RESULTS

| | s1 | s2 | s3 | s4 |
|---|---|---|---|---|
| Specimen width, mm | 132 | 132 | 132 | 132 |
| Specimen height, mm | 100 | 102.4 | 100 | 102.4 |
| Specimen length, mm | 212 | 212 | 212 | 184 |
| Mass, g | 254.9 | 316.9 | 255.6 | 274.4 |
| Effective Density, kg/m³ | 91.1 | 110.6 | 91.3 | 112.3 |
| Effective Strength, MPa | 2.1 | 2.07 | 1.9 | 0.67 |
| Effective Elastic Modulus, | 64.7 | 50 | 47.5 | 37.7 |
| MPa | | | | |
| Maximum Load, kN | 0.32863 | 0.67137 | 1.60 | 0.97635 |
| Load:mass ratio | 24000:1 | 19000:1 | 21000:1 | 7000:1 |

The findings demonstrate that there is no distinction in behavior between continuum and discrete origami assemblies. Furthermore, stretch-dominated and bending-dominated unit cells exhibited similar behavior during uniaxial compression. All Kirigami Extended Miura geometries were found to withstand up to three times the maximum load of a conventional corrugation with the same geometry and relative density value. Additionally, the breaking mode of the Kirigami Extended Miura demonstrated a much more ductile behavior, with the ability to absorb more energy when collapsing compared to the straight corrugation.

The anisotropy of flexural modulus for a given geometry was quantified by comparing stretch-dominated and bending dominated cells using three-point bending tests on four 8 by 2 by 2 beam specimens s5, s6, s7, and s8) with different architectures, identified below.
s5: cells oriented towards the y-axis in a stretch-dominated architecture.
s6: cells oriented towards the x-axis in a stretch-dominated architecture.
s7: cells oriented towards the y-axis in a bending-dominated architecture.
s8: cells oriented towards the x-axis in a bending-dominated architecture.

FIG. 7A and Table 2, below, summarize the experimental results.

TABLE 2
THREE-POINT BENDING TEST RESULTS

| | s5 | s6 | s7 | s8 |
|---|---|---|---|---|
| Specimen width, mm | 152 | 132 | 132 | 152 |
| Specimen height, mm | 102.4 | 102.4 | 102.4 | 102.4 |
| Specimen length, mm | 483 | 492 | 492 | 483 |
| Mass, g | 771 | 871 | 746 | 710 |
| Effective Density, kg/m³ | 102.6 | 131 | 112.2 | 94.4 |
| Bending Stiffness (EI), N · m² | 184 | 136 | 9.23 | 8.63 |
| Normal Force:Displacement ratio, | 221:1 | 158.5:1 | 11:1 | 10.6:1 |
| N/mm | | | | |

Comparing s5 with s8 and s6 with s7, a significant difference in flexural rigidity values was observed between architectures dominated by stretching and those dominated by bending, ranging from 14 to 21.3 times. Furthermore, both architectures exhibited similar flexural rigidity values in orthogonal axes, indicating isotropic behavior of the corrugation in the two principal axes.

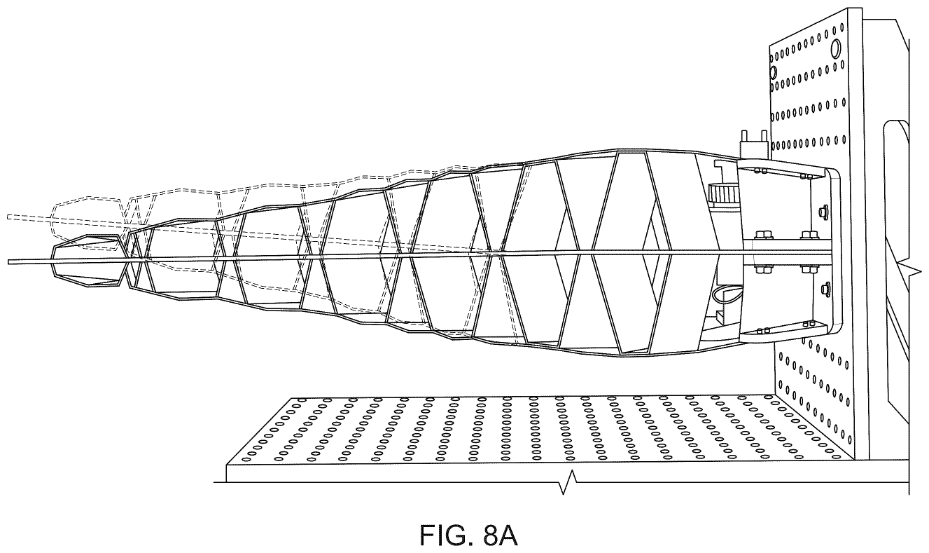

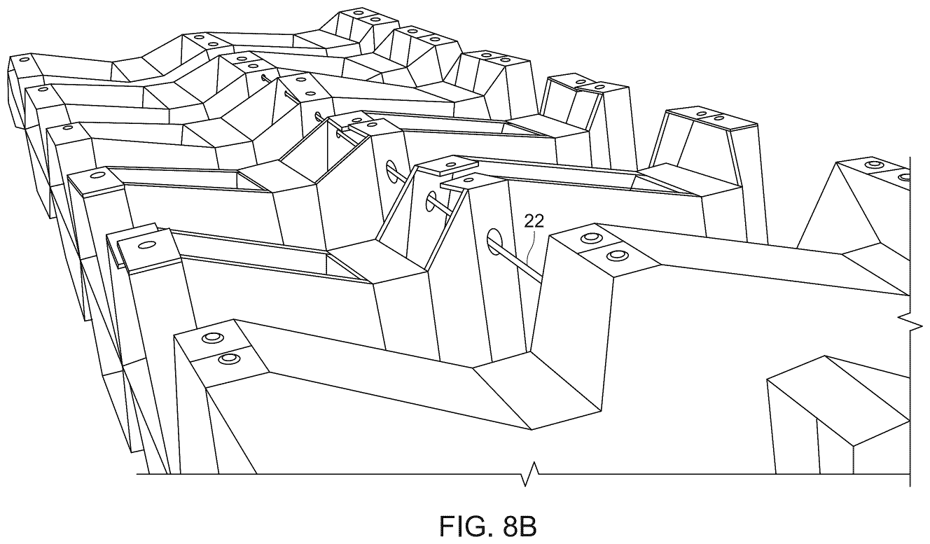

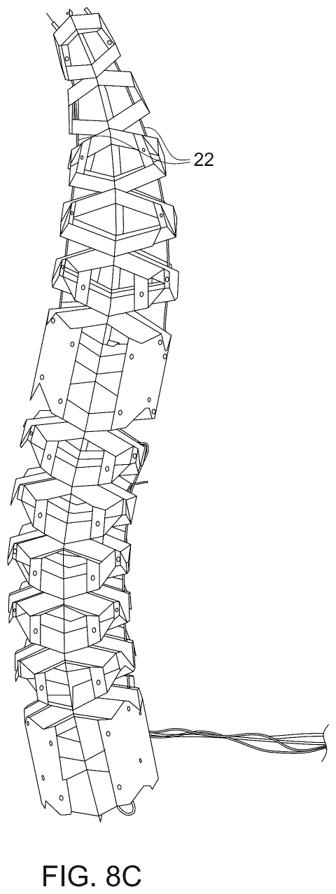

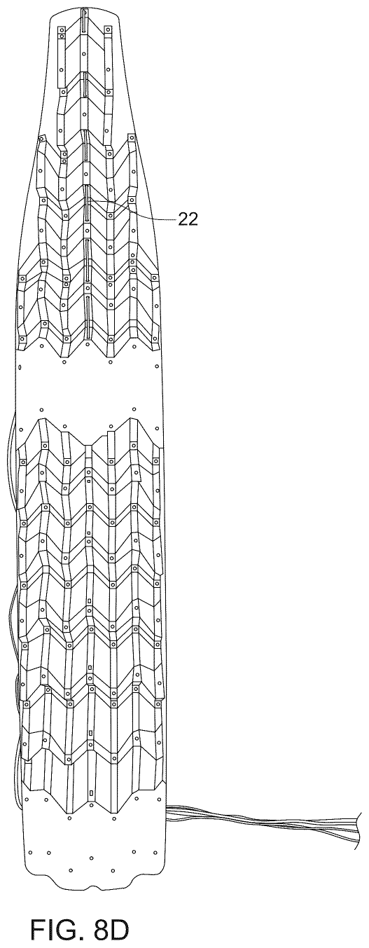

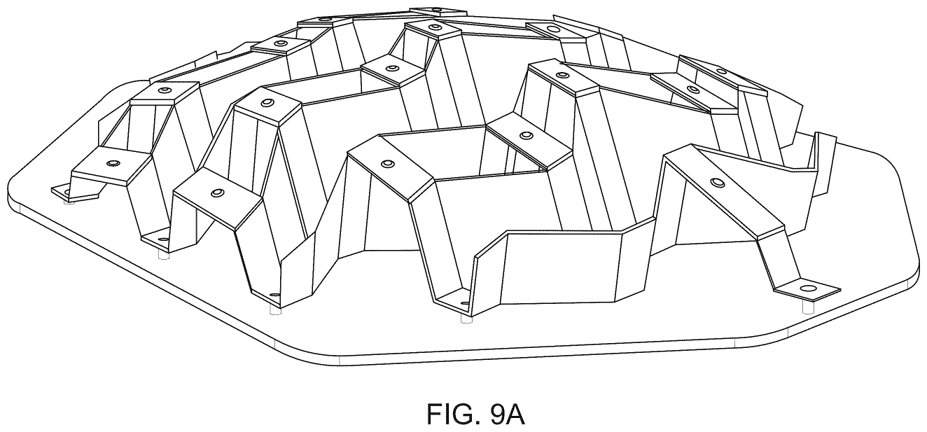

FIGS. 8A, 8B, 8C, and 8D depict two robots constructed using Kirigami corrugations: a single degree of freedom, single curvature morphing wing (FIGS. 8A and 8B) and a large-scale, two degree of freedom, doubly curved tentacle (FIGS. 8C and 8D). Actuation was achieved by tensioning steel wire tendons 22 routed across the surface of locally compliant regions of the structure. Actuator modules included closed-loop brushed direct current (DC) motors, each with a 160:1 gear reduction, and a proportional-integral-derivative (PID) position controller running at 5 kHz. Custom dual-shaft pulleys were used to simultaneously spool and unspool a pair of tendons on opposite sides of the centroid, to allow for bending in either direction without over-constraining the structure.

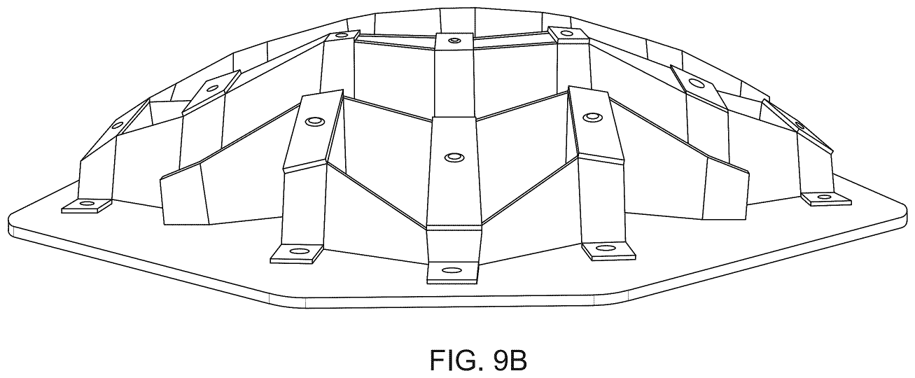

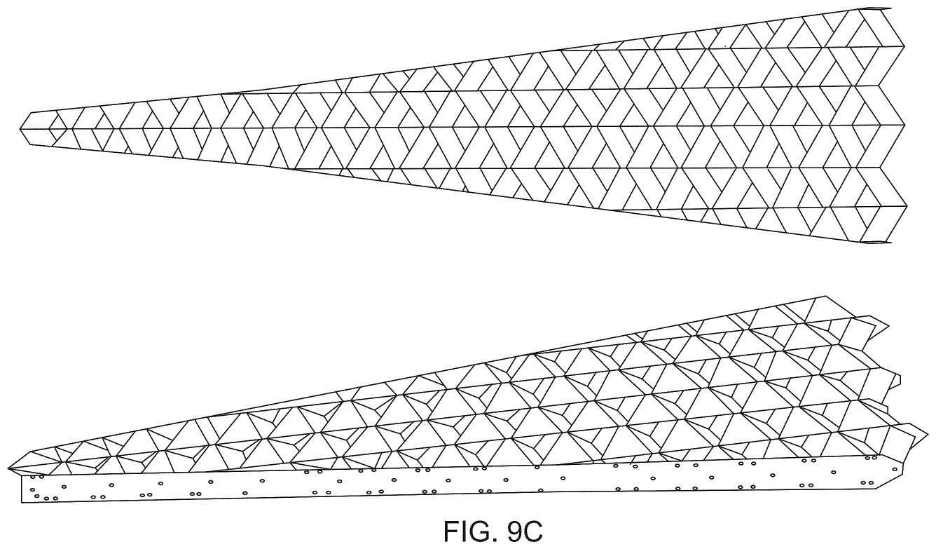

FIGS. 9A, 9B, and 9C display static structures constructed using Kirigami corrugations, a portion of which have single curvature and a portion of which have double curvature. FIGS. 9A and 9B depict a shell with double curvature. FIG. 9C depicts an HTP of a single aisle transatlantic airplane at 1:1 scale with single curvature.

It should be understood, of course, that the foregoing relates to exemplary embodiments of the invention and that modifications may be made without departing from the spirit and scope of the invention as set forth in the following claims.

### REFERENCES

[1] Zenkert, Dan. An Introduction to Sandwich Structures (1995). DOI 10.1115/MSEC2018-6646.
[2] Calisch, Sam and Gershenfeld, Neil. “Towards Continuous Production of Shaped Honeycombs.”: p. V003T02A007. 2018. DOI 10.1115/MSEC2018-6646.
[3] Cise, Lakes R. S., D. “Moisture ingression in honeycomb core sandwich panel.” 1997. DOI https://doi.org/10.1007/s11665-997-0074-4.
[4] Wicks, Nicole and Hutchinson, John. “Optimal Truss Plates.” International Journal of Solids and Structures—INT J SOLIDS STRUCT Vol. 38 (2001). DOI 10.1016/S0020-7683 (00) 00315-2.
[5] Wadley, H. N. G., Fleck, Norman and Evans, Anthony. “Fabrication and Structural Performance of Periodic Cellular Metal Sandwich Structures.” Composites Science and Technology Vol. 63 (2003): pp. 2331-2343. DOI 10.1016/S0266-3538(03)00266-5.
[6] Finnegan, K., Kooistra, G., Wadley, H. N. G. and Deshpande, V. S. “The compressive response of carbon fiber composite pyramidal truss sandwich cores.” International Journal of Materials Research-INT J MATER RES Vol. 98 (2007): pp. 1264-1272. DOI 10.3139/146.101594.
[7] Chen, Yijin, Scarpa, Fabrizio, Remillat, Chrystel, Farrow, Ian, Liu, Yanju and Leng, Jinsong. “Curved Kirigami SILICOMB cellular structures with zero Poisson's ratio for large deformations and morphing.” Journal of Intelligent Material Systems and Structures Vol. 25 No. 6 (2014): pp. 731-743. DOI 10.1177/1045389X13502852. URL https://doi.org/10.1177/1045389X13502852, URL https://doi.org/10.1177/1045389X13502852.
[8] Ozdemir, Nazli, Scarpa, Fabrizio, Craciun, Monica, Remillat, Chrystel, Lira, Cristian, Jagessur, Yogesh and Rocha-Schmidt, Luiz. “Morphing nacelle inlet lip with pneumatic actuators and a flexible nano composite sandwich panel.” Smart Materials and Structures Vol. 24 (2015). DOI 10.1088/0964-1726/24/12/125018.
[9] Saito, Kazuya, Pellegrino, Sergio and Nojima, Taketoshi. “Manufacture of Arbitrary Cross-Section Composite Honeycomb Cores Based on Origami Techniques.” Vol. 136. 2013. DOI 10.1115/DETC2013-12743.
[10] Calisch, Sam. “Folded Functional Foams.” 2019. MIT. URL https://cba.mit.edu/docs/theses/19.09.calisch.pdf.
[11] Hähnel, Falk, Wolf, Klaus, Hauffe, Andreas, Alekseev, Kirill and Zakirov, Il'dus. “Wedge-shaped folded sandwich cores for aircraft applications: From design and manufacturing process to experimental structure validation.” CEAS Aeronautical Journal Vol. 2 (2011). DOI 10.1007/s13272-011-0014-8.
[12] Miura, Koryo. “Zeta-Core Sandwich-Its Concept and Realization.” ISAS report/Institute of Space and Aeronautical Science, University of Tokyo Vol. 37 No. 6 (1972): pp. 137-164. URL https://cir.nii.ac.jp/crid/1050848249892668672.
[13] Neville, Robin and Scarpa, Fabrizio. “Design of Shape Morphing Cellular Structures and Their Actuation Methods.” 2015. DOI 10.13140/RG.2.1.4530.1527.
[14] Miura, Koryo. Zeta-Core Sandwich—Its Concept and Realization. Institute of Space and Aeronautical Science, University of Tokyo (1972).
[15] Gibson, Lorna J. and Ashby, Michael F. “Cellular Solids: Structure and Properties.” (1997) DOI 10.1017/CBO9781139878326.
[16] Akitaya, Hugo, Demaine, Erik D., Horiyama, Takashi, Hull, Thomas C., Ku, Jason S. and Tachi, Tomohiro. “Rigid Foldability is NP-Hard.” (2018) DOI 10.48550/ARXIV.1812.01160. URL https://arxiv.org/abs/1812.01160.
[17] Jenett, Benjamin, Cameron, Christopher, Tourlomousis, Filippos, Rubio, Alfonso Parra, Ochalek, Megan and Gershenfeld, Neil. “Discretely assembled mechanical metamaterials.” Science Advances Vol. 6 No. 47 (2020): p. eabc9943. DOI 10.1126/sciadv.abc9943. URL https://www.science.org/doi/pdf/10.1126/sciadv.abc9943, URL https://www.science.org/doi/abs/10.1126/sciadv.abc9943.
[18] Schenk, Mark and Guest, Simon D. “Geometry of Miura-folded metamaterials.” Proceedings of the National Academy of Sciences Vol. 110 No. 9 (2013): pp. 3276-3281. DOI 10.1073/pnas.1217998110. URL https://www.pnas.org/doi/abs/10.1073/pnas. 1217998110.

What is claimed is:

1. A structure comprising:
a core assembled from modules having Kirigami expanded Miura crease patterns; and
sandwich planes with the core positioned therebetween and joined thereto.

2. The structure of claim 1, wherein a first set of the modules satisfy Maxwell's Stability Criterion and a second set of the modules do not satisfy Maxwell's Stability Criterion, such that selected sections of the core have a flexural modulus lower than remaining sections of the core.

3. The structure of claim 1, wherein at least one parameter is predetermined, the at least one parameter selected from the group consisting of: dimensions of a zig-zag shape, length between neighboring pairs of the modules, a height between the sandwich planes, target vectors, dimensions of a lower base plane, inclination angle of rectangular faces, and any combinations thereof.

4. The structure of claim 1, wherein at least a portion of the modules exhibit double curvature.

5. The structure of claim 1, further comprising steel wire tendons routed across a surface of the core and/or at least one of the sandwich planes.

6. The structure of claim 5, further comprising at least one closed-loop brushed DC motor and a PID position controller, operative to tension the steel wire tendons.

7. The structure of claim 1, wherein the core is formed of polypropylene and the sandwich planes are formed of aluminum.

8. A method of manufacturing a structure comprising:
assembling a core from modules having Kirigami expanded Miura crease patterns; and
joining the core with a top surface and with a bottom surface by a step selected from the group consisting of bolting, riveting, co-curing, gluing, and any combination thereof.

9. The method of claim 8, further comprising offsetting overlapping faces and trim.

10. The method of claim 8, comprising providing an origami module having a Miura-ori crease pattern and extruding creases.

11. The method of claim 10, further comprising removing parallelograms formed by the extruding.

12. The method of claim 8, further comprising aligning corrugations of neighboring modules with a same crease assignment.

13. The method of claim 8, further comprising installing tendons operative to actuate modules.

14. The method of claim 8, wherein the crease pattern is produced on material to form the modules by a process selected from the group consisting of cold metal forming, double face milling, perforated creases, and any combination thereof.

15. The method of claim 8, further comprising assembling the core from neighboring cells that share geometric boundaries.

16. The method of claim 8, wherein the modules further comprise alternating cells dominated by stretching and cells dominated by bending.

17. A method of modifying a structure having a Miura-ori pattern into a structure having
a Kirigami expanded Miura pattern, the method comprising:
constructing a corrugation with vertex locations V_{i,j} and lengths (lₓ, l_{y}) where lₓ>0 and l_{y}>0 to specify a zig-zag shape of an xy-corrugation;
extruding the yz-corrugations in a x-parallel direction to both sides to create a modified tessellation having new rectangular faces corresponding to the yz-corrugations and new creases in the zig-zag polylines, resulting in modified xy-corrugations;
extruding the modified xy-corrugations in a y-parallel direction to both sides to create new parallelogram faces, and removing the new parallelogram faces to obtain a structure having a Kirigami Expanded Miura pattern.
